(19) United States
(12) Patent Application Publication
(10) Pub. No.: US 2024/0106954 A1
(43) Pub. Date: Mar. 28, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Masayoshi MIKI, Kanagawa (JP)

(73) Assignee: FUJIFILM Business Innovation Corp., Tokyo (JP)

(21) Appl. No.: 18/184,713

(22) Filed: Mar. 16, 2023

(30) Foreign Application Priority Data
Sep. 27, 2022 (JP) 2022-153316

(51) Int. Cl. H04N 1/00

(52) U.S. Cl. CPC H04N 1/00904; H04N 1/00896; H04N 2201/0096

(57) ABSTRACT

An information processing apparatus has apparatus modes set therein, the apparatus modes including a first mode in which the information processing apparatus is supplied with electric power to be used by the information processing apparatus for executing a process and a second mode in which the electric power supplied to the information processing apparatus is reduced such that the process is not executed, and includes a processor configured to perform control when a restore process involving restoring an apparatus mode to the first mode from the second mode is performed, the control including simultaneously supplying the electric power to a device presumed to be used in the information processing apparatus after the restore process.

### CROSS-REFERENCE TO RELATED APPLICATIONS

This application is based on and claims priority under 35 USC 119 from Japanese Patent Application No. 2022-153316 filed Sep. 27, 2022.

### BACKGROUND

### (i) Technical Field

The present disclosure relates to information processing apparatuses, information processing methods, and non-transitory computer readable media.

### (ii) Related Art

Japanese Unexamined Patent Application Publication No. 2014-89493 describes an image forming apparatus that supplies electric power to a device identified based on a function of a job process associated with an initial screen to be displayed when a controller is caused to transition to a standby mode.

Japanese Unexamined Patent Application Publication No. 2015-222909 describes an image forming apparatus that, when recovering from a sleep mode, switches an initialization process of each device in correspondence with a function of a setting screen to be displayed.

Japanese Unexamined Patent Application Publication No. 2018-8443 describes an image forming apparatus that determines whether or not received data is command data that involves supply of electric power to a memory when a receiver receives the data from an external device during a power-saving mode.

Japanese Unexamined Patent Application Publication No. 2020-129747 describes an image forming apparatus in which, when a factor for recovering from a sleep mode occurs, the image forming apparatus determines whether or not to supply electricity to a storage unit in accordance with the factor for recovering from the sleep mode.

### SUMMARY

Apparatus modes that may sometimes be set include a first mode in which an apparatus is supplied with electric power to be used by the apparatus for executing a process and a second mode in which the electric power supplied to the apparatus is reduced such that the process is not executed. When the apparatus mode is to be restored to the first mode from the second mode, it is conceivable that devices included in the apparatus are sequentially supplied with electric power. However, when the devices are sequentially supplied with electric power, a long period of time is used for completing the supply of electric power to the devices.

Aspects of non-limiting embodiments of the present disclosure relate to shortening the period of time used for completing the supply of electric power to the devices in a case where the set apparatus modes include the first mode in which the apparatus is supplied with electric power to be used by the apparatus for executing a process and the second mode in which the electric power supplied to the apparatus is reduced such that the process is not executed, as compared with a case where the devices are sequentially supplied with electric power when the apparatus mode is to be restored to the first mode from the second mode.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus having apparatus modes set therein, the apparatus modes including a first mode in which the information processing apparatus is supplied with electric power to be used by the information processing apparatus for executing a process and a second mode in which the electric power supplied to the information processing apparatus is reduced such that the process is not executed, the information processing apparatus comprising a processor configured to perform control when a restore process involving restoring an apparatus mode to the first mode from the second mode is performed, the control including simultaneously supplying the electric power to a device presumed to be used in the information processing apparatus after the restore process.

### BRIEF DESCRIPTION OF THE DRAWINGS

Exemplary embodiments of the present disclosure will be described in detail based on the following figures, wherein:

FIG. 1 is a block diagram illustrating a hardware configuration of an image forming apparatus according to an exemplary embodiment;

FIG. 2 is a diagram for explaining restore factors;

FIG. 3 illustrates a partial-restore setting screen;

FIG. 4 is a flowchart illustrating the flow of a process according to a first exemplary embodiment;

FIG. 5 is a flowchart illustrating the flow of the process according to the first exemplary embodiment;

FIG. 6 illustrates one or more devices to be supplied with electric power when a restore factor occurs;

FIG. 7 illustrates one or more devices to be supplied with electric power in correspondence with an initial screen;

FIG. 8 is a flowchart illustrating the flow of a process according to a third exemplary embodiment;

FIG. 9 is a flowchart illustrating the flow of the process according to the third exemplary embodiment; and

FIG. 10 illustrates a high-speed activation setting screen.

### DETAILED DESCRIPTION

An information processing apparatus according to an exemplary embodiment will be described below. The information processing apparatus according to this exemplary embodiment has a function for controlling the supply of electric power to the information processing apparatus, and may be any apparatus so long as the apparatus has such a function.

Power modes (i.e., power supplied states) of the information processing apparatus will now be described. The power modes set in the information processing apparatus include, for example, a power-on mode, a complete power-off mode, a power-saving mode, and a suspension mode. These power modes are merely examples, and other power modes may be set.

In the power-on mode, the information processing apparatus is activated as a result of a device (i.e., hardware) included in the information processing apparatus being supplied with electric power, and the information processing apparatus is capable of executing a process or an operation. In the power-on mode, devices included in the information processing apparatus are entirely or partially supplied with electric power. As will be described later, when the setting for partial restore is enabled, one or more of the devices are supplied with electric power. When the setting for partial restore is disabled, all of the devices are supplied with electric power. A state after the partial restore, to be described later, also corresponds to the power-on mode.

In the complete power-off mode, the devices included in the information processing apparatus are not supplied with electric power at all, such that there is no electricity applied to each device. For example, a state where the power plug of the information processing apparatus is removed from the wall outlet corresponds to the complete power-off mode.

In the power-saving mode, the power plug of the information processing apparatus is inserted in the wall outlet, and the information processing apparatus is activated as a result of restoring the power mode to the power-on mode when a restore factor occurs. In the power-saving mode, one or more of the devices (e.g., a device for detecting a restore factor and a device for controlling the supply of electric power during the restore process) included in the information processing apparatus are supplied with electric power, such that electricity is applied to these one or more devices. Examples of the restore factor include an operation for turning on the power (e.g., pressing of the power button), pressing of a restore-from-power-saving button, and a specific predetermined event. As the restore factor, a restore factor assumed as being an operation performed by a user or a restore factor assumed as not being an operation performed by the user may be set.

The suspension mode is a power mode realized as a result of executing a suspending function that the information processing apparatus has. In the suspension mode, the power plug of the information processing apparatus is inserted in the wall outlet, and the information processing apparatus is activated if an operation for turning on the power is performed (i.e., if the power button is pressed). For example, a state where one or more of the devices (e.g., a memory and a device for detecting that the power button is pressed) are supplied with electric power such that electricity is supplied to these one or more devices corresponds to the suspension mode. The memory is supplied with electric power used for retaining data.

When the power mode transitions from the power-on mode to the suspension mode in response to an operation for turning off the power (e.g., pressing of the power button), information indicating the status of each program executed prior to the transition of the power mode to the suspension mode (i.e., the status of each program executed prior to the operation for turning off the power) is stored in the memory (e.g., a random access memory (RAM)).

When the operation for turning on the power is performed (e.g., the power button is pressed) in the suspension mode, the power mode is restored to the power-on mode from the suspension mode, so that the information processing apparatus is activated. In this case, each program is restored to the previously-stored state in the memory without being reactivated. Accordingly, the time used for completing the restore may be shortened, as compared with a case where each program is reactivated. For example, in a case where the power mode is restored to the power-on mode from the power-saving mode, each program is reactivated. In this case, the suspension mode may be regarded as being a mode that uses a shorter period of time for the restore process, as compared with the power-saving mode. In this regard, the suspension mode may be regarded as being a high-speed activation function (i.e., a function for activating the information processing apparatus at high speed) or a high-speed restore function.

A power mode in which electric power used by the information processing apparatus for executing a process is supplied to each device included in the information processing apparatus will be referred to as “first mode”, and a power mode in which the electric power supplied to the information processing apparatus is reduced such that the process is not executed will be referred to as “second mode”.

For example, when the power mode is the power-on mode, the electric power used by the information processing apparatus for executing the process is supplied to each device included in the information processing apparatus. Therefore, the power-on mode corresponds to an example of the first mode.

When the power mode is the power-saving mode or the suspension mode, the electric power supplied to the information processing apparatus is reduced such that the process is not executed by the information processing apparatus. Therefore, the power-saving mode and the suspension mode each correspond to an example of the second mode.

In the following description of an exemplary embodiment, it is assumed that the first mode is the power-on mode and the second mode is the power-saving mode.

In the information processing apparatus according to this exemplary embodiment, when the power mode of the information processing apparatus is restored to the first mode from the second mode (i.e., the power mode transitions to the power-on mode from the power-saving mode), electric power is simultaneously supplied to a device presumed to be used in the information processing apparatus after the restore process.

A device to be supplied with electric power during the restore process may be varied for every restore factor for restoring the power mode from the second mode (e.g., the power-saving mode) to the first mode (e.g., the power-on mode). For example, a device to be supplied with electric power may be preliminarily set for every restore factor, such that the device is supplied with electric power in accordance with this setting when a restore factor occurs.

A device to be supplied with electric power during the restore process may be varied for every screen to be displayed after the power mode is restored to the first mode (e.g., the power-on mode) from the second mode (e.g., the power-saving mode). For example, a device to be supplied with electric power may be preliminarily set for every screen to be displayed after the restore process, such that the device is supplied with electric power in accordance with this setting when a restore factor occurs.

When a restore factor occurs, a device corresponding to the restore factor that has occurred and a device corresponding to a screen to be displayed after a restore process may be supplied with electric power.

Although an exemplary embodiment will be described below with reference to an image forming apparatus as an example of the information processing apparatus, the apparatus according to the exemplary embodiment is not limited to an image forming apparatus. This exemplary embodiment may be applied to an apparatus other than an image forming apparatus.

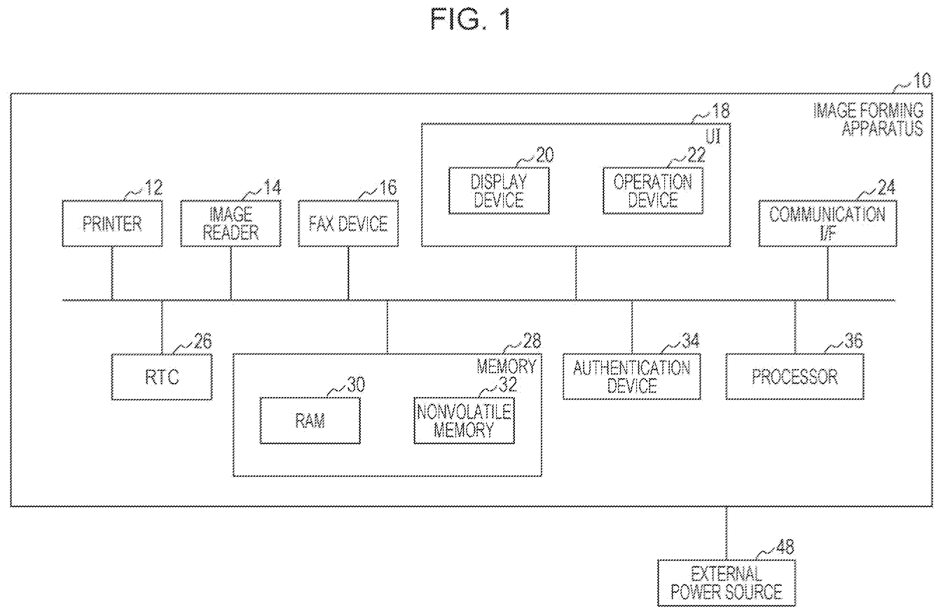

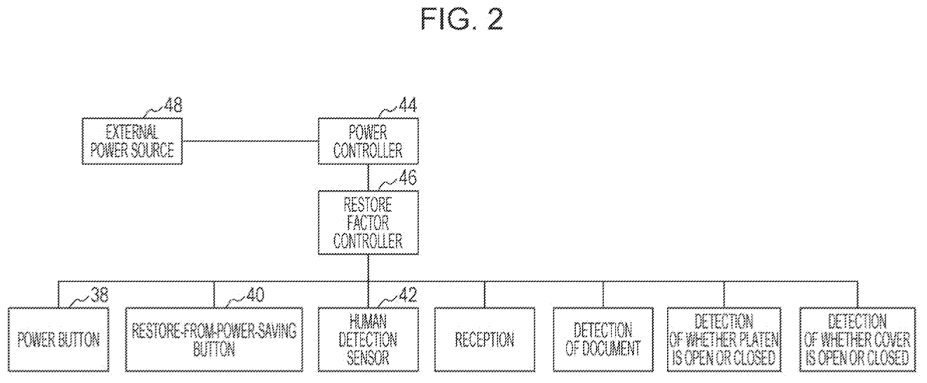

The configuration of an image forming apparatus 10 as an example of the information processing apparatus will now be described with reference to FIGS. 1 and 2. FIGS. 1 and 2 illustrate a hardware configuration of the image forming apparatus 10 as an example of the information processing apparatus.

The image forming apparatus 10 includes, for example, a printer 12, an image reader 14, a facsimile (FAX) device 16, a user interface (UI) 18, a communication interface (UF) 24, a real-time clock (RTC) 26, a memory 28, an authentication device 34, a processor 36, a power button 38, a restore-from-power-saving button 40, and a human detection sensor 42. The image forming apparatus 10 is connected to an external power source 48 and receives electric power supplied from the external power source 48.

The printer 12 prints an image onto a recording medium, such as a sheet. The printing method is not particularly limited and may be, for example, an electrophotographic method or an inkjet method. The image reader 14 is, for example, a scanner and reads an image from, for example, a sheet. The printer 12 and the image reader 14 implement a copying function. The FAX device 16 uses a facsimile function to transmit and receive information. As an alternative to the example shown in FIG. 1 in which the image forming apparatus 10 includes the printer 12, the image reader 14, and the FAX device 16, the image forming apparatus 10 may include at least one of the printer 12, the image reader 14, and the FAX device 16. The image forming apparatus 10 may be a multifunctional apparatus including multiple devices among the printer 12, the image reader 14, and the FAX device 16.

The UI 18 is a user interface that includes, for example, a display device 20 and an operation device 22. The display device 20 is, for example, a liquid crystal display or an electroluminescence (EL) display. The operation device 22 is, for example, a keyboard, a mouse, an input button, or an operation panel. The UI 18 may alternatively be a touchscreen.

The communication OF 24 is a communication interface having, for example, a communication chip and/or a communication circuit, and has a function for transmitting information to another device and a function for receiving information from another device. The communication OF 24 may have a wireless communication function, such as near field communication (e.g., Bluetooth (registered trademark)) or Wi-Fi (registered trademark), or may have a wired communication function. Alternatively, for example, Ethernet (registered trademark) may be used.

The RTC 26 is a real-time clock that generates information about the time and date from a clock source and outputs the information.

The memory 28 has one or more storage regions for storing data. The memory 28 includes a RAM 30 and a nonvolatile memory 32. The nonvolatile memory 32 used may be, for example, an electrically erasable programmable read-only memory (EEPROM) or a flash memory. The memory 28 also includes a boot read-only memory (ROM) that has stored therein a program for activating the image forming apparatus 10. Furthermore, the memory 28 may include a hard disk drive (HDD), a solid state drive (SSD), a memory other than the RAM 30, or another storage device (e.g., an optical disk).

The authentication device 34 performs user authentication. For example, the authentication device 34 includes an integrated-circuit (IC) card reader and authenticates a user by reading authentication information (e.g., user identification information and password) from an authentication IC card. The authentication device 34 may authenticate the user by using, for example, biological information (e.g., fingerprint or venous information). The authentication device 34 may authenticate the user by receiving authentication information, such as a user ID and a password, in accordance with a method other than the method of using an IC card. For example, the user may operate the UI 18 to input the authentication information, such as the user ID and the password, to the image forming apparatus 10. If the authentication is successful, the user is permitted to log into the image forming apparatus 10, whereby the user is able to use functions usable after the log-in. If the authentication is not successful, the user is not permitted to log into the image forming apparatus 10. Alternatively, the authentication process may be performed by an apparatus (e.g., an authentication server) other than the image forming apparatus 10.

The processor 36 controls the operation of each component of the image forming apparatus 10. For example, the processor 36 controls a printing process performed by the printer 12, an image reading process performed by the image reader 14, an information exchanging process performed by the FAX device 16, and a communication process performed by the communication OF 24.

The power button 38 is a command button used for turning the power of the image forming apparatus 10 between an on mode and an off mode.

The restore-from-power-saving button 40 is a command button used for restoring the power mode of the image forming apparatus 10 to the power-on mode from the power-saving mode. In a case where the power mode of the image forming apparatus 10 is the power-saving mode, when the restore-from-power-saving button 40 is pressed, the processor 36 causes the power mode of the image forming apparatus 10 to transition from the power-saving mode to the power-on mode.

The human detection sensor 42 detects a person present in the vicinity of the image forming apparatus 10. A known human detection sensor is used as the human detection sensor 42. For example, an infrared, ultrasonic, or visible-light human detection sensor is used as the human detection sensor 42.

The image forming apparatus 10 also includes a power controller 44 and a restore factor controller 46. The power controller 44 controls the power mode of the image forming apparatus 10. The restore factor controller 46 detects a restore factor.

For example, the power controller 44 and the restore factor controller 46 are included in the processor 36, and the function of the power controller 44 and the function of the restore factor controller 46 are implemented by the processor 36.

FIG. 2 illustrates an example of restore factors. The restore factors include, for example, pressing of the power button 38, pressing of the restore-from-power-saving button 40, detection of a person by the human detection sensor 42, reception of data (e.g., reception by the FAX device 16 or reception by the communication OF 24), detection of a document (e.g., detection of a document by an automatic document feeder or detection of a document by a duplex automatic document feeder (DADF)), detection of whether a platen provided in the image forming apparatus 10 is open or closed, and detection of whether a cover (e.g., a front cover) provided in the image forming apparatus 10 is open or closed.

The printer 12, the image reader 14, the FAX device 16, the UI 18, the communication OF 24, the RTC 26, the memory 28, the authentication device 34, the processor 36, the power button 38, the restore-from-power-saving button 40, and the human detection sensor 42 each correspond to an example of a device included in the image forming apparatus 10.

As mentioned above, the power modes set in the image forming apparatus 10 include, for example, the power-on mode, the complete power-off mode, the power-saving mode, and the suspension mode.

When the power mode of the image forming apparatus 10 is to be restored to the power-on mode from the power-saving mode, the processor 36 performs control for simultaneously supplying electric power to a device presumed to be used in the image forming apparatus 10 after the restore process.

For example, a device to be supplied with electric power is preliminarily set for every restore factor, and information indicating this setting is stored in the memory 28 (e.g., the nonvolatile memory 32). When a restore factor occurs, the power controller 44 refers to this information to identify a device corresponding to the restore factor and controls the supply of electric power to the identified device. Accordingly, the identified device is supplied with electric power from the external power source 48.

A screen to be displayed after a restore process may be set as an initial screen, and information indicating the initial screen may be stored in the memory 28 (e.g., the nonvolatile memory 32). Furthermore, a device to be supplied with electric power may be preliminarily set for every screen (i.e., initial screen) to be displayed after a restore process, and information indicating this setting may be stored in the memory 28 (e.g., the nonvolatile memory 32). When a restore factor occurs, the power controller 44 identifies the initial screen to be displayed after a restore process, identifies the device corresponding to this initial screen, and controls the supply of electric power from the external power source 48 to the identified device. Accordingly, the identified device is supplied with electric power from the external power source 48.

In the suspension mode, a device for detecting that the power button 38 is pressed and the RAM 30 are supplied with electric power. The RAM 30 is supplied with electric power used for retaining data. When the power mode transitions from the power-on mode to the suspension mode, information indicating the status of each program executed prior to the transition of the power mode to the suspension mode (e.g., the status of each program executed before the power button 38 is pressed) is stored in the RAM 30. If the power button 38 is pressed and the pressing thereof is detected when the power mode is the suspension mode, the power mode is restored to the power-on mode from the suspension mode, so that the image forming apparatus 10 is activated. In this case, each program is restored to the previously-stored state in the RAM 30 without being reactivated.

When the power mode of the image forming apparatus 10 is the power-on mode, if a condition for transitioning to the power-saving mode is satisfied, the power controller 44 causes the power mode to transition from the power-on mode to the power-saving mode. For example, if the image forming apparatus 10 is not operated for a predetermined time period or longer, if the image forming apparatus 10 does not execute a process for a predetermined time period or longer, or if the power button 38 or the restore-from-power-saving button 40 is pressed, the power mode transitions from the power-on mode to the power-saving mode.

When the power mode of the image forming apparatus 10 is the power-on mode, if a condition for transitioning to the suspension mode is satisfied, the processor 36 causes the power mode to transition from the power-on mode to the suspension mode.

The condition for transitioning to the power-saving mode and the condition for transitioning to the suspension mode are preliminarily set. These conditions may be changed by the user.

The operation of the image forming apparatus 10 will be described below. The following description relates to an example where the power mode of the image forming apparatus 10 transitions to the power-saving mode and is subsequently restored to the power-on mode from the power-saving mode.

In this exemplary embodiment, the setting for partial restore is enabled or disabled by the user. Partial restore refers to a restore method in which electric power is supplied to a specific device alone when a restore factor occurs. For example, the specific device is a device presumed to be used in the image forming apparatus 10 after the power mode is restored to the power-on mode from the power-saving mode. For example, a device to be used in the image forming apparatus 10 may be set for every restore factor or for every initial screen.

When partial restore is set to the enabled mode, electric power is supplied to the specific device alone when a restore factor occurs. For example, a device corresponding to the restore factor may be supplied with electric power, or a device corresponding to the initial screen may be supplied with electric power.

When partial restore is set to the disabled mode, all of the devices are supplied with electric power when a restore factor occurs.

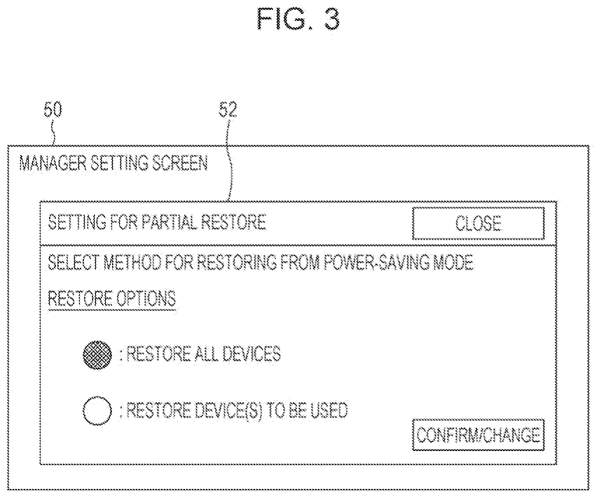

FIG. 3 illustrates a partial-restore setting screen. For example, when the user operates the UI 18 to give a command for displaying a manager setting screen 50, the processor 36 causes the display device 20 to display the manager setting screen 50. When the user gives a command for displaying a partial-restore setting screen on the manager setting screen 50, the processor 36 causes the display device 20 to display a partial-restore setting screen 52.

On the setting screen 52, a method for restoring the power mode to the power-on mode from the power-saving mode is designated. In detail, partial restore is set to the enabled mode or the disabled mode.

If the user selects a “restore all devices” option, partial restore is set to the disabled mode. If the user selects a “restore device(s) to be used” option, partial restore is set to the enabled mode. Information indicating whether partial restore is enabled or disabled is stored in, for example, the memory 28 (e.g., the nonvolatile memory 32). When a restore factor occurs, the power controller 44 refers to this information and controls the electric power in accordance with the partial restore setting. The power controller 44 executes partial restore if the setting for partial restore is enabled, and supplies electric power to all the devices if the setting for partial restore is disabled.

First, second, third, and fourth exemplary embodiments will be described below. The first exemplary embodiment relates to a case where the setting for partial restore is disabled. The second, third, and fourth exemplary embodiments each relate to a case where partial restore is set to the enabled mode.

### First Exemplary Embodiment

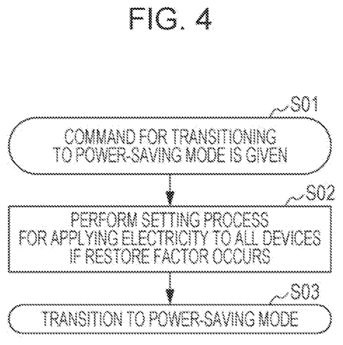

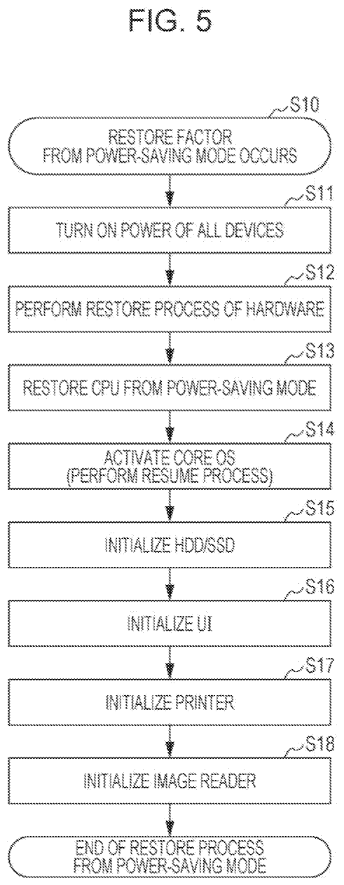

The first exemplary embodiment will now be described with reference to FIGS. 4 and 5. FIGS. 4 and 5 are flowcharts each illustrating the flow of a process according to the first exemplary embodiment.

First, a process performed when the power mode transitions to the power-saving mode will be described with reference to FIG. 4. Then, a process performed when the power mode is restored to the power-on mode from the power-saving mode will be described with reference to FIG. 5.

As shown in FIG. 4, when the condition for transitioning to the power-saving mode is satisfied and a command for transitioning to the power-saving mode is given in step S01, the power controller 44 performs a setting process in step S02 for applying electricity to all the devices if a restore factor occurs. For example, information indicating the setting is stored in the memory 28 (e.g., the nonvolatile memory 32). Subsequently, in step S03, the power controller 44 causes the power mode of the image forming apparatus 10 to transition to the power-saving mode.

As shown in FIG. 5, when the restore factor controller 46 detects that the restore factor for restoring the power mode from the power-saving mode has occurred in step S10, the power controller 44 simultaneously turns on the power of all the devices in step S11. Accordingly, all the devices are supplied with electric power from the external power source 48. For example, the printer 12, the image reader 14, the FAX device 16, the UI 18, the communication OF 24, the HDD or the SSD included in the memory 28, and the authentication device 34 are supplied with electric power. Then, in step S12, a restore process of the devices (i.e., hardware) is performed. When a restore factor occurs, the devices implementing the power controller 44 and the restore factor controller 46 are first supplied with electric power, the restore factor controller 46 detects the restore factor, and the power controller 44 controls the supply of electric power. If the power mode is the power-saving mode, the devices implementing the power controller 44 and the restore factor controller 46 may be supplied with electric power during the power-saving mode.

First, a central processing unit (CPU) included in the processor 36 is restored from the power-saving mode in step S13. Then, in step S14, a core operating system (OS) is activated.

Subsequently, the HDD or the SSD is initialized in step S15, the UI 18 is initialized in step S16, the printer 12 is initialized in step S17, and the image reader 14 is initialized in step S18. Moreover, the communication OF 24, the FAX device 16, and the authentication device 34 are initialized.

After undergoing the initialization described above, the image forming apparatus 10 is restored to the power-on mode from the power-saving mode.

### Second Exemplary Embodiment

In a second exemplary embodiment, one or more devices to be supplied with electric power during a restore process are set for every restore factor. One or more devices presumed to be used in the image forming apparatus 10 after the restore process are set for every restore factor, and the one or more devices presumed to be used are set as the one or more devices to be supplied with electric power during the restore process.

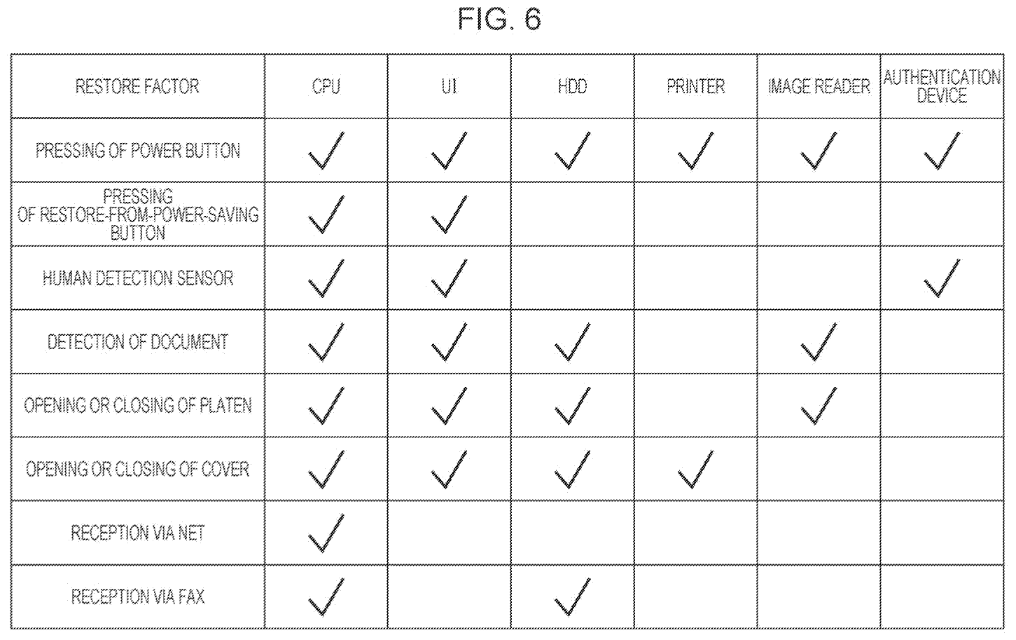

The second exemplary embodiment will be described with reference to FIG. 6. FIG. 6 illustrates a setting table indicating one or more devices to be supplied with electric power. This setting table indicates one or more devices to be supplied with electric power during a restore process for every restore factor. The data in the setting table is stored in the memory 28 (e.g., the nonvolatile memory 32).

In the setting table shown in FIG. 6, information indicating a restore factor and information indicating one or more devices to be supplied with electric power during a restore process are associated with each other for every restore factor. The one or more devices associated with each restore factor are one or more devices presumed to be used after a restore process.

For example, the restore factors shown in FIG. 6 include “pressing of power button 38”, “pressing of restore-from-power-saving button 40”, “detection by human detection sensor 42”, “detection of document”, “detection of whether platen is open or closed”, “detection of whether cover is open or closed”, “reception via net”, and “reception via fax”. The restore factors shown in FIG. 6 are merely examples, and other restore factors are set and registered in the setting table.

For example, the restore factor “pressing of power button 38” is associated with “CPU”, “UI 18”, “HDD”, “printer 12”, “image reader 14”, and “authentication device 34”. When the restore factor controller 46 detects an occurrence of the restore factor “pressing of power button 38”, the CPU, the UI 18, the HDD, the printer 12, the image reader 14, and the authentication device 34 are supplied with electric power. With regard to each of the remaining restore factors, when the restore factor occurs, each device associated with the restore factor is supplied with electric power.

For example, the restore factor “pressing of power button 38” is associated with “CPU”, “UI 18”, “HDD”, “printer 12”, “image reader 14”, and “authentication device 34”. If the power button 38 is pressed when the power mode is the power-saving mode, the power controller 44 supplies electric power to the CPU included in the processor 36, the UI 18, the HDD, the printer 12, the image reader 14, and the authentication device 34.

For example, when the user desires to perform printing or scanning by using the image forming apparatus 10, it is conceivable that the user may press the power button 38. In other words, it is presumed that, when the power button 38 is pressed, the user desires to perform printing or scanning by using the image forming apparatus 10. Thus, when the restore factor “pressing of power button 38” occurs, the power controller 44 supplies electric power to the CPU, the UI 18, the HDD, the printer 12, the image reader 14, and the authentication device 34.

The restore factor “pressing of restore-from-power-saving button 40” is associated with “CPU” and “UI 18”. If the restore-from-power-saving button 40 is pressed when the power mode is the power-saving mode, the power controller 44 supplies electric power to the CPU and the UI 18.

For example, when the user desires to cancel the power-saving mode and operate the image forming apparatus 10, it is conceivable that the user may press the restore-from-power-saving button 40. In other words, it is presumed that, when the restore-from-power-saving button 40 is pressed, the user desires to operate the image forming apparatus 10. Thus, when the restore factor “pressing of restore-from-power-saving button 40” occurs, the power controller 44 supplies electric power to the CPU and the UI 18.

The restore factor “detection by human detection sensor 42” is associated with “CPU”, “UI 18”, and “authentication device 34”. If the human detection sensor 42 detects a person when the power mode is the power-saving mode, the power controller 44 supplies electric power to the CPU, the UI 18, and the authentication device 34.

For example, when the user approaches the image forming apparatus 10 to operate the image forming apparatus 10, it is conceivable that the human detection sensor 42 detects a person. In other words, it is presumed that, when a person is detected by the human detection sensor 42, the person is present in the vicinity of the image forming apparatus 10 and is trying to operate the image forming apparatus 10. Thus, when the restore factor “detection by human detection sensor 42” occurs, the power controller 44 supplies electric power to the CPU, the UI 18, and the authentication device 34.

The restore factor “detection of document” is associated with “CPU”, “UI 18”, “HDD”, and “image reader 14”. If a document is placed on the DADF and is detected when the power mode is the power-saving mode, the power controller 44 supplies electric power to the CPU, the UI 18, the HDD, and the image reader 14.

For example, when the user desires to execute scanning, it is conceivable that the user may place a document on the DADF. In other words, it is presumed that, when a document is detected, the user desires to use the scanning function of the image reader 14. Thus, when the restore factor “detection of document” occurs, the power controller 44 supplies electric power to the CPU, the UI 18, the HDD, and the image reader 14.

The restore factor “reception via net” is associated with the CPU alone. At the time point of the reception, it is not clear whether the reception is reception of data to be printed or reading of data simply stored in a memory. Therefore, the CPU alone is supplied with electric power to reduce power consumption.

With regard to each of the remaining restore factors, when the restore factor occurs, one or more devices associated with the restore factor are similarly supplied with electric power. Specifically, when the restore factor occurs, one or more devices presumed to be used after a restore process caused by the restore factor are supplied with electric power.

Accordingly, one or more devices corresponding to each restore factor are supplied with electric power, so that one or more devices presumed to be used after a restore process are supplied with electric power, whereas one or more devices presumed not to be used after the restore process are not supplied with electric power. As a result, power consumption may be reduced, as compared with a case where all the devices are supplied with electric power regardless of the restore factor.

### Third Exemplary Embodiment

In a third exemplary embodiment, one or more devices to be supplied with electric power during a restore process are set for every initial screen to be displayed after the power mode is restored to the power-on mode from the power-saving mode. For example, a screen that is frequently used after a restore process or a screen that the user plans to use is set as an initial screen. The initial screen is set by the user. A frequently-used screen may be set as an initial screen without being set by the user.

For each initial screen, one or more devices for implementing a process to be executed by operating the initial screen are set. Since the one or more devices are presumed to be used after a restore process, the one or more devices are set as one or more devices to be supplied with electric power during the restore process.

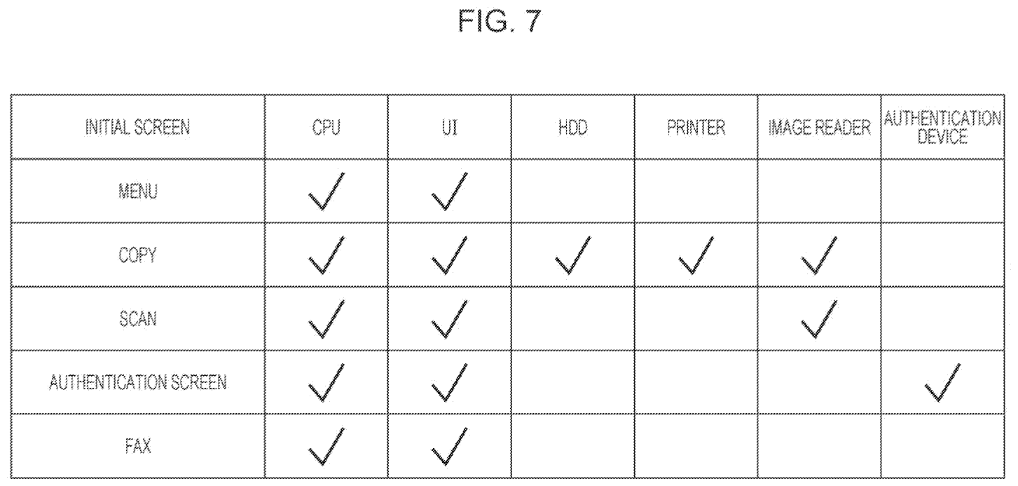

The third exemplary embodiment will be described with reference to FIG. 7. FIG. 7 illustrates a setting table indicating one or more devices to be supplied with electric power. This setting table indicates one or more devices to be supplied with electric power in correspondence with each initial screen. The data in the setting table is stored in the memory 28 (e.g., the nonvolatile memory 32).

In the setting table shown in FIG. 7, information indicating an initial screen and information indicating one or more devices to be supplied with electric power during a restore process are associated with each other for every initial screen. The one or more devices associated with each initial screen are presumed to be used after the restore process.

For example, “menu”, “copy”, “scan”, “authentication screen”, and “FAX” are shown in FIG. 7 as the initial screens. Each of these screens is displayed on the UI 18.

“Menu” denotes a menu screen. The menu screen displays a list of images (e.g., icons) used for executing corresponding processes or for designating settings. For example, images associated with a copying process, a scanning process, an authentication process, and a facsimile process are displayed on the menu screen.

“Copy” denotes a copy setting screen. The copy setting screen displays fields and items to be used for inputting copying conditions.

“Scan” denotes a scan setting screen. The scan setting screen displays fields and items to be used for inputting scanning conditions.

“Authentication screen” is a screen that is displayed on the UI 18 when the authentication device 34 performs authentication.

“FAX” denotes a FAX setting screen. The FAX setting screen displays fields and items to be used for inputting facsimile conditions.

The initial screens shown in FIG. 7 are merely examples, and other initial screens are set and registered in the setting table.

For example, the initial screen “menu” is associated with “CPU” and “UI 18”. If the restore factor controller 46 detects a restore factor when “menu” is set as the initial screen, the power controller 44 supplies electric power to the CPU included in the processor 36 and to the UI 18. Then, the menu screen is displayed as the initial screen on the UI 18. In the third exemplary embodiment, a restore factor may be any restore factor. The same applies to the following description.

When the menu screen is set as the initial screen, it is presumed that the user may operate the menu screen after a restore process. Thus, if a restore factor occurs when “menu” is set as the initial screen, the power controller 44 supplies electric power to the CPU and the UI 18.

The initial screen “copy” is associated with “CPU”, “UI 18”, “HDD”, “printer 12”, and “image reader 14”. If the restore factor controller 46 detects a restore factor when “copy” is set as the initial screen, the power controller 44 supplies electric power to the CPU, the UI 18, the HDD, the printer 12, the image reader 14, and the authentication device 34. Then, the copy setting screen is displayed on the UI 18. Since copying is implemented by the printer 12 and the image reader 14, the printer 12 and the image reader 14 are supplied with electric power. The UI 18 is supplied with electric power for displaying the copy setting screen, the CPU is supplied with electric power for performing copy control, and the HDD is supplied with electric power for storing data.

When the copy setting screen is set as the initial screen, it is presumed that the user may give a copy execution command after a restore process. Thus, if a restore factor occurs when “copy” is set as the initial screen, the power controller 44 supplies electric power to the CPU, the UI 18, the HDD, the printer 12, and the image reader 14.

The initial screen “scan” is associated with “CPU”, “UI 18”, and “image reader 14”. If the restore factor controller 46 detects a restore factor when “scan” is set as the initial screen, the power controller 44 supplies electric power to the CPU, the UI 18, and the image reader 14. Then, the scan setting screen is displayed on the UI 18. Since scanning is implemented by the image reader 14, the image reader 14 is supplied with electric power. The UI 18 is supplied with electric power for displaying the scan setting screen, and the CPU is supplied with electric power for performing scan control.

When the scan setting screen is set as the initial screen, it is presumed that the user may give a scan execution command after a restore process. Thus, if a restore factor occurs when “scan” is set as the initial screen, the power controller 44 supplies electric power to the CPU, the UI 18, and the image reader 14.

The initial screen “authentication screen” is associated with “CPU”, “UI 18”, and “authentication device 34”. If the restore factor controller 46 detects a restore factor when “authentication screen” is set as the initial screen, the power controller 44 supplies electric power to the CPU, the UI 18, and the authentication device 34. Then, the authentication screen is displayed on the UI 18. Since authentication is implemented by the authentication device 34, the authentication device 34 is supplied with electric power. The UI 18 is supplied with electric power for displaying the authentication screen, and the CPU is supplied with electric power for controlling the display.

When the authentication screen is set as the initial screen, it is presumed that the user may log into the image forming apparatus 10 by performing authentication after a restore process. Thus, if a restore factor occurs when “authentication screen” is set as the initial screen, the power controller 44 supplies electric power to the CPU, the UI 18, and the authentication device 34.

With regard to each of the remaining initial screens, when a restore factor occurs, one or more devices corresponding to the set initial screen are supplied with electric power. Specifically, when the restore factor occurs, one or more devices presumed to be used via the initial screen are supplied with electric power.

Accordingly, one or more devices corresponding to each initial screen is supplied with electric power, so that one or more devices presumed to be used after a restore process are supplied with electric power, whereas the remaining one or more devices presumed not to be used after the restore process are not supplied with electric power. As a result, power consumption may be reduced, as compared with a case where all the devices are supplied with electric power regardless of the initial screen.

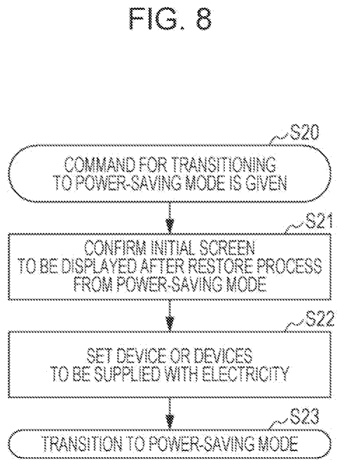

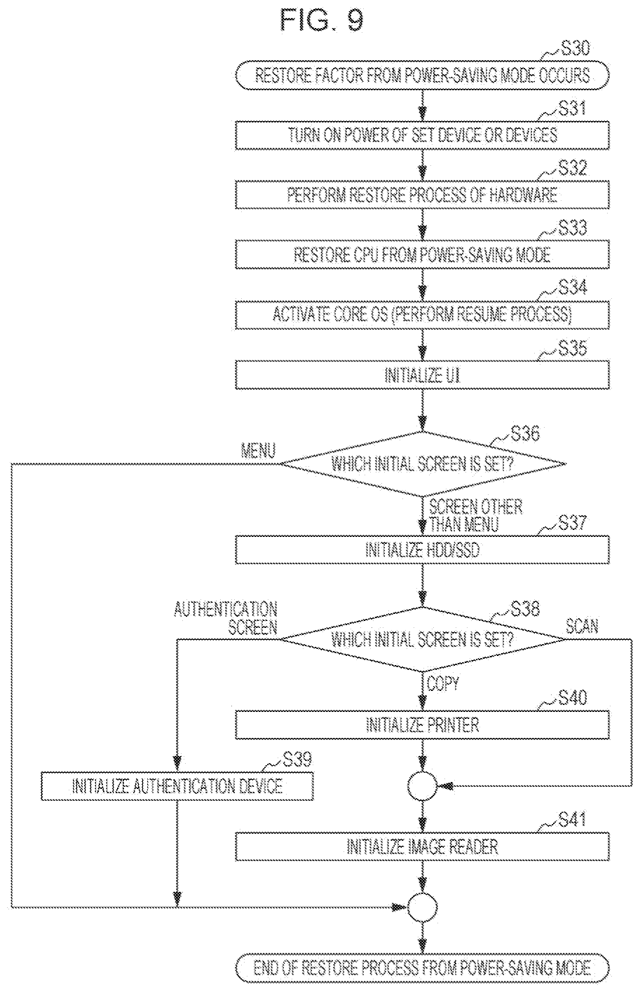

The flow of a process according to the third exemplary embodiment will now be described with reference to FIGS. 8 and 9. FIGS. 8 and 9 are flowcharts each illustrating the flow of the process according to the third exemplary embodiment.

First, a process performed when the power mode transitions to the power-saving mode will be described with reference to FIG. 8. Then, a process performed when the power mode is restored to the power-on mode from the power-saving mode will be described with reference to FIG. 9.

As shown in FIG. 8, when the condition for transitioning to the power-saving mode is satisfied and a command for transitioning to the power-saving mode is given in step S20, the power controller 44 confirms an initial screen to be displayed after a restore process in step S21, and sets one or more devices corresponding to the initial screen as one or more devices to be supplied with electricity in step S22. Then, in step S23, the power controller 44 causes the power mode of the image forming apparatus 10 to transition to the power-saving mode.

As shown in FIG. 9, when the restore factor controller 46 detects that a restore factor for restoring the power mode from the power-saving mode has occurred in step S30, the power controller 44 turns on the power of the set one or more devices (i.e., the set one or more devices corresponding to the initial screen) in step S31. Then, a restore process of the one or more devices (i.e., hardware) is performed in step S32.

First, the CPU included in the processor 36 is restored from the power-saving mode in step S33. Then, the core OS is activated in step S34. Subsequently, the UI 18 is initialized in step S35.

If “menu” is set as the initial screen (“menu” in step S36), the restore process ends.

If a screen other than “menu” is set as the initial screen, the HDD or the SSD is initialized in step S37.

If “authentication screen” is set as the initial screen (“authentication screen” in step S38), the authentication device 34 is initialized in step S39.

If “copy” is set as the initial screen (“copy” in step S38), the printer 12 is initialized in step S40, and the image reader 14 is initialized in step S41.

If “scan” is set as the initial screen (“scan” in step S38), the image reader 14 is initialized in step S41.

After undergoing the initialization described above, the image forming apparatus 10 is restored to the power-on mode from the power-saving mode.

### Fourth Exemplary Embodiment

A fourth exemplary embodiment is a combination of the second and third exemplary embodiments.

The fourth exemplary embodiment is similar to the second exemplary embodiment in that one or more devices to be supplied with electric power during a restore process are set for every restore factor, and is similar to the third exemplary embodiment in that one or more devices to be supplied with electric power during a restore process are set for every initial screen to be displayed after the restore process. For example, the data in the setting table shown in FIG. 6 and the data in the setting table shown in FIG. 7 are stored in the memory 28 (e.g., the nonvolatile memory 32).

When the restore factor controller 46 detects that a restore factor has occurred, the power controller 44 supplies electric power to one or more devices corresponding to the restore factor that has occurred and to one or more devices corresponding to an initial screen.

For example, in a case where “menu” is set as the initial screen, if a document is placed on the DADF when the power mode is the power-saving mode, the power controller 44 supplies electric power to the CPU, the UI 18, the HDD, and the image reader 14. If the CPU and the UI 18 are supplied with electric power (see FIG. 7) but the restore factor is “detection of document” when “menu” is set as the initial screen, the HDD and the image reader 14 are also supplied with electric power (see FIG. 6). Since it is presumed that the image reader 14 is to be used after a restore process when the restore factor is “detection of document”, the image reader 14 is also supplied with electric power.

The power controller 44 may change the one or more devices to be supplied with electric power depending on whether or not the restore factor that has occurred is assumed as being an operation performed by the user.

In detail, when a restore factor assumed as being an operation performed by the user occurs, the power controller 44 supplies electric power to one or more devices corresponding to the restore factor that has occurred and to one or more devices corresponding to an initial screen.

On the other hand, when a restore factor assumed as not being an operation performed by the user occurs, the power controller 44 supplies electric power to one or more devices corresponding to the restore factor that has occurred. Specifically, of the one or more devices corresponding to the restore factor that has occurred and the one or more devices corresponding to the initial screen, the power controller 44 supplies electric power to the one or more devices corresponding to the restore factor without supplying electric power to the one or more devices corresponding to the initial screen alone. More specifically, if a certain device corresponds to both the initial screen and the restore factor that has occurred, the power controller 44 supplies electric power to the device. If a certain device corresponds to the initial screen alone but does not correspond to the restore factor that has occurred, the power controller 44 does not supply electric power to the device. If a certain device does not correspond to the initial screen but corresponds to the restore factor that has occurred, the power controller 44 supplies electric power to the device.

A restore factor assumed as being an operation performed by the user is, for example, a restore factor assumed as being an operation performed on the UI 18 (i.e., an operation performed on a screen displayed on the UI 18) after a restore process.

Examples of the restore factor assumed as being an operation performed by the user include “pressing of power button 38”, “pressing of restore-from-power-saving button 40”, “detection of document”, “opening or closing of platen”, and “opening or closing of cover”. For example, when a document is placed on the DADF, it is presumed that scanning is to be executed. In other words, when a document is placed on the DADF, it is presumed that the user may subsequently operate the UI 18 and give a scan execution command. Accordingly, “detection of document” is a restore factor assumed as being an operation performed by the user. The same applies to each of the remaining restore factors. In this case, the power controller 44 supplies electric power to one or more devices corresponding to the restore factor in addition to one or more devices corresponding to an initial screen.

A restore factor assumed as not being an operation performed by the user is, for example, a restore factor assumed as not being an operation performed on the UI 18 after a restore process.

Examples of the restore factor assumed as not being an operation performed by the user include “reception via net”, “reception via fax”, and “detection by human detection sensor 42”.

Since an operation panel included in the UI 18 is not to be turned on in “reception via fax”, the UI 18 is not supplied with electric power. Furthermore, data received via fax is sometimes stored in the memory, such as the HDD, without being printed. In this case, the printer 12 is not supplied with electric power. Accordingly, since “reception via fax” is assumed as not being an operation performed by the user, the power controller 44 supplies electric power to one or more devices corresponding to the restore factor that has occurred. Specifically, the power controller 44 refers to the setting table shown in FIG. 6 without referring to the setting table shown in FIG. 7, and supplies electric power to one or more devices in accordance with the setting table shown in FIG. 6.

In a configuration where the operation panel included in the UI 18 is turned on or the printer 12 is activated and generates an activation sound when a user not intended to use the image forming apparatus 10 simply passes by the vicinity of the image forming apparatus 10, such a configuration may surprise the user or may lead to wasteful consumption of electric power. Specifically, when the restore factor “detection by human detection sensor 42” occurs, the UI 18 and the printer 12 are not supplied with electric power. Since “detection by human detection sensor 42” is assumed as not being an operation performed by the user, the power controller 44 supplies electric power to one or more devices corresponding to the restore factor that has occurred. Specifically, the power controller 44 refers to the setting table shown in FIG. 6 without referring to the setting table shown in FIG. 7, and supplies electric power to one or more devices in accordance with the setting table shown in FIG. 6.

Specific examples of the fourth exemplary embodiment will be described below.

### First Specific Example

If “detection by human detection sensor 42” occurs as a restore factor when “copy” is set as an initial screen, the printer 12 is also supplied with electric power when one or more devices corresponding to the initial screen and one or more devices corresponding to the restore factor are supplied with electric power. Even when the user simply arrives at the image forming apparatus 10 to collect a printed sheet or simply passes by the vicinity of the image forming apparatus 10, the printer 12 is supplied with electric power. In other words, the printer 12 is supplied with electric power even when the printer 12 is not to be used.

Thus, if “detection by human detection sensor 42” occurs as the restore factor when “copy” is set as the initial screen, the power controller 44 supplies electric power to one or more devices corresponding to the restore factor “detection by human detection sensor 42”. In other words, the power controller 44 supplies electric power to the one or more devices in accordance with the setting table shown in FIG. 6.

### Second Specific Example

In a second specific example, the power controller 44 supplies electric power to a part of one or more devices corresponding to a restore factor that has occurred.

For example, as shown in FIG. 6, when the restore factor “detection by human detection sensor 42” occurs, the UI 18 is also supplied with electric power. However, as mentioned above, the human detection sensor 42 may sometimes detect a user even in a case where the user does not intend to use the image forming apparatus 10. A case where the user simply arrives at the image forming apparatus 10 to collect a sheet or a case where the user simply passes by the vicinity of the image forming apparatus 10 corresponds to an example of the case where the user does not intend to use the image forming apparatus 10. In this case, the power controller 44 supplies electric power to the body of the UI 18 but does not supply the UI 18 with electric power for turning on a display, such as the operation panel.

### Third Specific Example

In a third specific example, a restore factor that has occurred is detection of a person by the human detection sensor 42.

For example, the human detection sensor 42 has a function for measuring the distance between the image forming apparatus 10 and the person detected by the human detection sensor 42.

As another example, the image forming apparatus 10 may be provided with multiple human detection sensors 42 with different measurable distances. For example, with reference to the location of the image forming apparatus 10, the image forming apparatus 10 may be provided with a human detection sensor 42 having a function for detecting a person present in a short range and a human detection sensor 42 having a function for detecting a person present in a long range. Moreover, the image forming apparatus 10 may be provided with a human detection sensor 42 having a function for detecting a person present in an intermediate range.

The power controller 44 controls the supply of electric power to one or more devices corresponding to an initial screen after a restore process and one or more devices corresponding to a restore factor that has occurred in accordance with the positional relationship between the person detected by each human detection sensor 42 and the image forming apparatus 10. The positional relationship between the person and the image forming apparatus 10 (e.g., the distance between the person and the image forming apparatus 10) is detected by each human detection sensor 42.

If the distance between the person detected by each human detection sensor 42 and the image forming apparatus 10 exceeds a threshold value, the power controller 44 supplies electric power to the one or more devices corresponding to the restore factor that has occurred. In this case, the power controller 44 supplies electric power to one or more devices corresponding to the restore factor “detection by human detection sensor 42”.

If the distance between the person detected by each human detection sensor 42 and the image forming apparatus 10 is smaller than or equal to the threshold value, the power controller 44 supplies electric power to the one or more devices corresponding to the restore factor that has occurred and to the one or more devices corresponding to the initial screen after the restore process. In this case, the power controller 44 supplies electric power to one or more devices corresponding to the restore factor “detection by human detection sensor 42” and to the one or more devices corresponding to the initial screen.

The threshold value is a predetermined value. The threshold value may be changed by the user. A range below or equal to the threshold value with reference to the location of the image forming apparatus 10 is the short range, and a range exceeding the threshold value with reference to the location of the image forming apparatus 10 is the long range. For example, a person present within the short range is detected by the short-range human detection sensor 42, and a person present within the long range is detected by the long-range human detection sensor 42. Needless to say, the distance between the image forming apparatus 10 and a person may be measured by a human detection sensor 42 having a distance measuring function. A range other than the short range and the long range, such as an intermediate range, may also be set.

If the distance between the person detected by each human detection sensor 42 and the image forming apparatus 10 exceeds the threshold value, for example, the power controller 44 refers to the setting table shown in FIG. 6 without referring to the setting table shown in FIG. 7, and supplies electric power to one or more devices in accordance with the setting table shown in FIG. 6. For example, even in a case where “copy” is set as the initial screen, the power controller 44 does not supply electric power to the printer 12 or the image reader 14. Since it is presumed that the image forming apparatus 10 is not to be used by a user when there is no one present within the short range, the power controller 44 does not supply electric power to the one or more devices corresponding to the initial screen.

If the distance between the person detected by each human detection sensor 42 and the image forming apparatus 10 is smaller than or equal to the threshold value, for example, the power controller 44 supplies electric power to one or more devices in accordance with the setting table shown in FIG. 6 and the setting table shown in FIG. 7. For example, in a case where “copy” is set as the initial screen, the power controller 44 supplies electric power to the printer 12 and the image reader 14. Since it is presumed that the image forming apparatus 10 is to be used by a user when there is a person present within the short range, the power controller 44 also supplies electric power to the one or more devices corresponding to the initial screen.

The short-range human detection sensor 42 may sometimes detect a person before the long-range human detection sensor 42 does. Corresponding examples include a case where a person moves in front of the image forming apparatus 10 from a direction not detectable by the long-range human detection sensor 42, a case where the short-range human detection sensor 42 and the long-range human detection sensor 42 detect a person substantially at the same time as a result of the person approaching the image forming apparatus 10 by running, and a case where a person is already within the short range when the power mode has transitioned to the power-saving mode.

Modifications will be described below.

### First Modification

If a specific operation is performed on the image forming apparatus 10 when the power mode is the power-saving mode, the power controller 44 may supply electric power to all the devices included in the image forming apparatus 10.

For example, if the restore-from-power-saving button 40 is pressed for a predetermined time period or longer (i.e., if the restore-from-power-saving button 40 is long-pressed) or if the restore-from-power-saving button 40 and another button are simultaneously pressed, the power controller 44 supplies electric power to all the devices.

For example, in the third exemplary embodiment in which one or more devices corresponding to an initial screen are supplied with electric power, if the specific operation is performed on the image forming apparatus 10, the power controller 44 supplies electric power to all the devices in addition to the one or more devices corresponding to the initial screen.

For example, if a restore factor occurs when the initial screen is “menu”, “CPU” and “UI 18” are supplied with electric power in the third exemplary embodiment, but the user may desire that the power mode be restored to the power-on mode for executing copying. In the third exemplary embodiment, when the user operates a copy icon displayed on the UI 18, the printer 12 and the image reader 14 are supplied with electric power. For example, in a case where the printer 12 includes a fuser, if the printer 12 is supplied with electric power from the aforementioned time point, the time period it takes until copy is executed is extended for the duration of time used for heating the fuser. With all the devices being supplied with electric power when the specific operation is performed, the aforementioned time period may be reduced.

In the fourth exemplary embodiment in which one or more devices corresponding to a restore factor are supplied with electric power, if the specific operation is performed on the image forming apparatus 10, the power controller 44 may supply electric power to all the devices in addition to the one or more devices corresponding to the restore factor.

### Second Modification

The power controller 44 may change one or more devices to be supplied with electric power depending on how the restore-from-power-saving button 40 is pressed.

For example, if the restore-from-power-saving button 40 is long-pressed when the power mode is the power-saving mode, the power controller 44 supplies electric power simultaneously to all the devices.

As another example, if the restore-from-power-saving button 40 is pressed multiple consecutive times (e.g., twice) within a predetermined period when the power mode is the power-saving mode, the power controller 44 supplies electric power simultaneously to all the devices.

As yet another example, if the restore-from-power-saving button 40 and another button are simultaneously pressed when the power mode is the power-saving mode, the power controller 44 supplies electric power simultaneously to all the devices.

### Third Modification

The process described in each of the exemplary embodiments and the modifications described above is executed when the power mode is to be restored to the power-on mode from the power-saving mode.

A process to be described in a third modification is executed when the power mode is to be restored to the power-on mode from the suspension mode.

As mentioned above, in the suspension mode, one or more of the devices (e.g., the memory and the device for detecting that the power button 38 is pressed) included in the image forming apparatus 10 are supplied with electric power. Therefore, the restore factor is “pressing of power button 38”.

If the restore factor “pressing of power button 38” is detected when the power mode is the suspension mode, the power controller 44 supplies electric power simultaneously to all the devices.

As another example, the power controller 44 may supply electric power to one or more devices corresponding to an initial screen, similarly to the third exemplary embodiment.

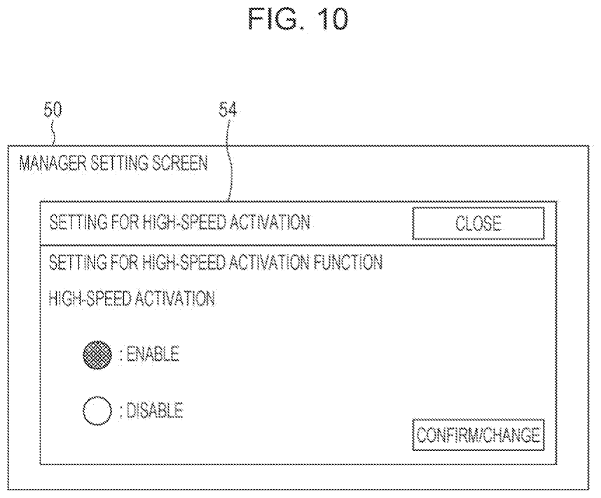

FIG. 10 illustrates a screen used for setting high-speed activation (i.e., suspension mode). For example, when the user operates the UI 18 to give a command for displaying the manager setting screen 50, the processor 36 causes the display device 20 to display the manager setting screen 50. When the user gives a command for displaying a high-speed-activation setting screen on the manager setting screen 50, the processor 36 causes the display device 20 to display a high-speed-activation setting screen 54.

On the setting screen 54, high-speed activation is set to an enabled mode or a disabled mode. In a case where high-speed activation is set to the enabled mode, the power controller 44 causes the power mode to transition to the suspension mode when the condition for transitioning to the suspension mode is satisfied.

In a case where the high-speed activation is set to the disabled mode, the power controller 44 causes the power mode to transition to the power-saving mode when the condition for transitioning to the power-saving mode is satisfied. Even when the condition for transitioning to the suspension mode is satisfied, the power controller 44 does not cause the power mode to transition to the suspension mode.

Each function of the image forming apparatus 10 is implemented by, for example, hardware and software operating in cooperation with each other. For example, the processor 36 of the image forming apparatus 10 reads a program stored in the memory 28 and executes the program, whereby each function of the image forming apparatus 10 is implemented. The program is stored in the memory 28 via a storage medium, such as a compact disc (CD) or a digital versatile disc (DVD), or via a communication path, such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus having apparatus modes set therein, the apparatus modes including a first mode in which the information processing apparatus is supplied with electric power to be used by the information processing apparatus for executing a process and a second mode in which the electric power supplied to the information processing apparatus is reduced such that the process is not executed, the information processing apparatus comprising:
a processor configured to:
   perform control when a restore process involving restoring an apparatus mode to the first mode from the second mode is performed, the control including simultaneously supplying the electric power to a device presumed to be used in the information processing apparatus after the restore process.
(((2)))

The information processing apparatus according to (((1))), wherein the processor is configured to change a device to be supplied with the electric power during the restore process for every restore factor from the second mode to the first mode.
(((3)))

The information processing apparatus according to (((1))) or (((2))), wherein the processor is configured to change a device to be supplied with the electric power during the restore process for every screen to be displayed after the restore process.
(((4)))

The information processing apparatus according to any one of (((1))) to (((3))),
wherein the device to be supplied with the electric power during the restore process is set for every restore factor,
wherein the device to be supplied with the electric power during the restore process is set for every screen to be displayed after the restore process, and
wherein, when a restore factor from the second mode to the first mode occurs, the processor is configured to control the electric power supplied to a device corresponding to the restore factor that has occurred and a device corresponding to a screen to be displayed after the restore process.
(((5)))

The information processing apparatus according to (((4))), wherein, when a restore factor assumed as being an operation performed by a user occurs, the processor is configured to control the electric power supplied to the device corresponding to the restore factor that has occurred and the device corresponding to the screen to be displayed after the restore process.
(((6)))

The information processing apparatus according to (((4))) or (((5))), wherein, when a restore factor assumed as not being an operation performed by a user occurs, the processor is configured to control the electric power supplied to the device corresponding to the restore factor that has occurred.
(((7)))

The information processing apparatus according to (((6))), wherein the processor is configured to control the electric power supplied to a part of the device corresponding to the restore factor that has occurred.
(((8)))

The information processing apparatus according to any one of (((4))) to (((7))),
wherein the restore factor that has occurred is detection of a person by a human detection sensor, and
wherein the processor is configured to control the electric power supplied to the device corresponding to the screen to be displayed after the restore process and the device corresponding to the restore factor that has occurred in accordance with a positional relationship between the detected person and the information processing apparatus.
(((9)))

The information processing apparatus according to (((8))), wherein the processor is configured to control the electric power supplied to the device corresponding to the restore factor that has occurred if a distance between the detected person and the information processing apparatus exceeds a threshold value.
(((10)))

The information processing apparatus according to (((8))) or (((9))), wherein the processor is configured to control the electric power supplied to the device corresponding to the restore factor that has occurred and the device corresponding to the screen to be displayed after the restore process if a distance between the detected person and the information processing apparatus is smaller than or equal to a threshold value.
(((11)))

The information processing apparatus according to any one of (((1))) to (((10))), wherein the processor is configured to control the electric power supplied to all devices if a specific operation is performed on the information processing apparatus.
(((12)))

A program causing a computer to execute a process for processing information, the computer being equipped in an apparatus having apparatus modes set therein, the apparatus modes including a first mode in which the apparatus is supplied with electric power to be used by the apparatus for executing a process and a second mode in which the electric power supplied to the apparatus is reduced such that the process is not executed, the process comprising:
performing control when a restore process involving restoring an apparatus mode to the first mode from the second mode is performed, the control including simultaneously supplying the electric power to a device presumed to be used in the apparatus after the restore process.

What is claimed is:

1. An information processing apparatus having apparatus modes set therein, the apparatus modes including a first mode in which the information processing apparatus is supplied with electric power to be used by the information processing apparatus for executing a process and a second mode in which the electric power supplied to the information processing apparatus is reduced such that the process is not executed, the information processing apparatus comprising:
a processor configured to:
perform control when a restore process involving restoring an apparatus mode to the first mode from the second mode is performed, the control including simultaneously supplying the electric power to a device presumed to be used in the information processing apparatus after the restore process.

2. The information processing apparatus according to claim 1, wherein the processor is configured to change a device to be supplied with the electric power during the restore process for every restore factor from the second mode to the first mode.

3. The information processing apparatus according to claim 1, wherein the processor is configured to change a device to be supplied with the electric power during the restore process for every screen to be displayed after the restore process.

4. The information processing apparatus according to claim 2,
wherein the device to be supplied with the electric power during the restore process is set for every restore factor,
wherein the device to be supplied with the electric power during the restore process is set for every screen to be displayed after the restore process, and
wherein, when a restore factor from the second mode to the first mode occurs, the processor is configured to control the electric power supplied to a device corresponding to the restore factor that has occurred and a device corresponding to a screen to be displayed after the restore process.

5. The information processing apparatus according to claim 4, wherein, when a restore factor assumed as being an operation performed by a user occurs, the processor is configured to control the electric power supplied to the device corresponding to the restore factor that has occurred and the device corresponding to the screen to be displayed after the restore process.

6. The information processing apparatus according to claim 4, wherein, when a restore factor assumed as not being an operation performed by a user occurs, the processor is configured to control the electric power supplied to the device corresponding to the restore factor that has occurred.

7. The information processing apparatus according to claim 5, wherein, when a restore factor assumed as not being an operation performed by a user occurs, the processor is configured to control the electric power supplied to the device corresponding to the restore factor that has occurred.

8. The information processing apparatus according to claim 6, wherein the processor is configured to control the electric power supplied to a part of the device corresponding to the restore factor that has occurred.

9. The information processing apparatus according to claim 7, wherein the processor is configured to control the electric power supplied to a part of the device corresponding to the restore factor that has occurred.

10. The information processing apparatus according to claim 4,
wherein the restore factor that has occurred is detection of a person by a human detection sensor, and
wherein the processor is configured to control the electric power supplied to the device corresponding to the screen to be displayed after the restore process and the device corresponding to the restore factor that has occurred in accordance with a positional relationship between the detected person and the information processing apparatus.

11. The information processing apparatus according to claim 10, wherein the processor is configured to control the electric power supplied to the device corresponding to the restore factor that has occurred if a distance between the detected person and the information processing apparatus exceeds a threshold value.

12. The information processing apparatus according to claim 10, wherein the processor is configured to control the electric power supplied to the device corresponding to the restore factor that has occurred and the device corresponding to the screen to be displayed after the restore process if a distance between the detected person and the information processing apparatus is smaller than or equal to a threshold value.

13. The information processing apparatus according to claim 1, wherein the processor is configured to control the electric power supplied to all devices if a specific operation is performed on the information processing apparatus.

14. A non-transitory computer readable medium storing a program causing a computer to execute a process for processing information, the computer being equipped in an apparatus having apparatus modes set therein, the apparatus modes including a first mode in which the apparatus is supplied with electric power to be used by the apparatus for executing a process and a second mode in which the electric power supplied to the apparatus is reduced such that the process is not executed, the process comprising:
performing control when a restore process involving restoring an apparatus mode to the first mode from the second mode is performed, the control including simultaneously supplying the electric power to a device presumed to be used in the apparatus after the restore process.

15. An information processing method executable in an apparatus having apparatus modes set therein, the apparatus modes including a first mode in which the apparatus is supplied with electric power to be used by the apparatus for executing a process and a second mode in which the electric power supplied to the apparatus is reduced such that the process is not executed, the information processing method comprising:
performing control when a restore process involving restoring an apparatus mode to the first mode from the second mode is performed, the control including simultaneously supplying the electric power to a device presumed to be used in the apparatus after the restore process.
